(19) United States
(12) Patent Application Publication
(10) Pub. No.: US 2016/0001741 A1
(43) Pub. Date: Jan. 7, 2016

(54) APPARATUS AND METHOD FOR BYPASSING WIRELESS VEHICLE IMMOBILIZERS

(71) Applicant: Directed, LLC, Vista, CA (US)

(72) Inventors: Peter Fazi, Lachine (CA); Martin Bouchard, Lachine (CA)

(21) Appl. No.: 14/791,372

(22) Filed: Jul. 3, 2015

Related U.S. Application Data
(60) Provisional application No. 62/020,832, filed on Jul. 3, 2014.

(51) Int. Cl. B60R 25/20; B60R 25/24

(52) U.S. Cl. CPC B60R 25/209; B60R 25/241; B60R 2325/105

(57) ABSTRACT

A remote start immobilizer bypass system records signals of an authorized key transponder and emulates the key transponder signals in response to receipt of a remote start command from a remote controller. To extend the range and facilitate placement of the remote start immobilizer bypass system within a vehicle, the emulated signals are reinforced by emitting the emulated signals in-phase and out-of-phase relative to the immobilizer coil signal used for inductively-coupled communications between the key transponder and the immobilizer coil. The in-phase and out-of-phase signals are generated in accordance with the recorded key transponder signals.

### CROSS-REFERENCE TO RELATED APPLICATION

This application claims priority from U.S. provisional patent application Ser. No. 62/020,832, entitled WIRELESS VEHICLE IMMOBILIZER BYPASS, filed on Jul. 3, 2014. which is hereby incorporated by reference in its entirety as if fully set forth herein, including text, figures, claims, tables, and computer program listing appendices (if present), and all other matter in the provisional patent application.

### FIELD

The present document relates generally to vehicle remote starting systems, and more particularly, to electronic circuitry for bypassing vehicle electronic immobilizer systems.

### BACKGROUND

A vehicle anti-theft system with remote start capability is a convenient means of protecting a vehicle from theft and of remotely starting the vehicle engine for various purposes, such as to warm or cool the vehicle's cabin before entry by a user. A typical anti-theft systems with remote start capability may have a central processing unit, various sensors that provide inputs that signal the conditions or status of various vehicle systems, subsystems, and components. The sensors may provide, for example, emergency brake status signal, door pin (open/close) status signal, hood pin (open/close) status signal, motion sensor status signal, shock sensor status signal, proximity sensor status signal, engine run status signal, and inputs from a number of other sensors used with vehicle anti-theft and remote start systems to determine vehicle status and automate command functions. Additional electronics security and/or remote start modules may include a passive anti-theft bypass sub-module and an analog to digital conversion sub-module. The anti-theft or a remote start system may also include a transceiver module with an antenna located within the vehicle that allows use of a radio frequency (RF) remote control transmitter to communicate remote start commands from a distance to the vehicle. Such remote control transmitters may be integrated with a key or a key fob carried by the user of the vehicle. The remote control transmitter (or, simply, a “remote controller”) may be paired with a specific receiver (or several specific receivers) at the vehicle, by storing into the module memory of the receiver an identification code of the individual transmitter(s), so that the receiver can identify the remote control transmitter(s) from the signals transmitted from the transmitter(s). Transmitter(s) having an identification code which are not recorded into the memory of the receiver will not be functional with the receiver. (For clarity, we describe operation with a single specific remote control transmitter, with the understanding that multiple such transmitters may be coupled with one or more specific receivers, and vice versa.) Using a remote transmitter is more convenient than using an ignition key, because it enables the user to control the starting of the vehicle from a remote/convenient location; this allows, for example, the vehicle to be warmed or cooled before entering the vehicle.

A vehicle may have an anti-theft system installed at the factory. Passive anti-theft systems are one type of known anti-theft system that function based on the wireless transmission of a coded identification signal from a transponder embedded into the grip of the mechanical ignition key, thus providing an electronic identification and authentication of the key. Generally, the transponder should be in proximity to the ignition cylinder switch, in order to enable starting of the engine and driving of the vehicle. This is so because the ignition cylinder may be surrounded or wrapped with an electrical immobilizer coil that, when energized from a source at the vehicle, acts as an inductive coupler or transmitter. The inductive transmission from the immobilizer coil at the ignition cylinder provides power to the key transponder when the key is inserted into the ignition cylinder. When inductively coupled with the induction coil, the key transponder is energized to transmit an electronic identifier or ID code. The ID code may be received and read by the immobilizer coil and further transmitted to a microprocessor (or other type of processing circuitry, such as a microcontroller, discrete component processing circuitry, a dedicated hardware processing module, and analogous device. The processing devices may be part of the vehicle's electronic control module (ECM) that performs other functions, for example, functions relating to driving, engine control, navigating, and infotainment. Upon validation of the ID code, the ECM starts the engine or enables engine starting.

International Organization for Standardization (ISO) communications protocols for frequencies of 125 kHz, 135 kHz, and 13.56 MHz may be used for the coupling between the key transponder and the coil installed in the vehicle for energizing and/or reading the key transponder. Higher frequencies that are used for RFID tagging may also be used, possibly with somewhat different communication methods. For example, communications at the 2.45 GHz band may be true RF links, that is, radiation-based RF links, while communications at the 125 kHz, 135 kHz, and 13.56 MHz frequencies may be using primarily transformer-type or inductive electromagnetic coupling. This does not exclude radiation based links for the 13.56 MHz and even lower frequencies.

Passive anti-theft systems deter theft since the driver needs to have an authorized ignition key transponder with a valid electronic ID code to be communicated to the ECM to activate the vehicle start function and drive away the vehicle. Usually, an authorized key transponder is programmed to couple to the passive anti-theft systems by recording in a memory within the ECM the transponder ID code of the key transponder. The same ID code must be communicated to the control unit to enable vehicle operation. (Of course, there may be several authorized keys with the same or different ID codes.) In variations of the above concept, an electronic ID signal is communicated to a control unit (such as the ECM) in order to enable engine starting. For example, an electrically resistive pellet may be embedded into the ignition key and the ID signal may be determined by the resistance value of the pellet.

With such techniques for passive anti-theft protection, generally only the manufacturer of the vehicle or of the immobilizer can provide a system in which a given coded signal for engine starting can be transmitted by either the key transponder or a remote transmitting unit, to enable starting of the engine from a distance without trigging the anti-theft system. The aforementioned systems perform so efficiently that they often cause problems to remote starter manufacturers and installers trying to retrofit a remote starting system on vehicles equipped with such transponder-based anti-theft immobilizer systems. Passive anti-theft systems have thus posed obstacles for manufacturers of aftermarket remote start systems.

To overcome a passive anti-theft immobilizer system, manufactures of aftermarket remote start systems have developed control units that bypass or mimic the signal normally communicated by the ignition key transponder. One method to mimic the ID code is to use a physically valid ignition key with a coded transponder permanently installed within the vehicle, and inductively coupled to the immobilizer coil of the ignition key cylinder assembly. When the remote start system is activated through the remote transmitter, the relay is energized and the key transponder located within the vehicle becomes inductively coupled to the immobilizer coil wrapped about the ignition cylinder. The ID code transmitted from the key transponder and carrying the code or a confirmation signal is then received by the ECM and engine starting is enabled. Unfortunately, this technique requires a key transponder (which may be expensive) to be permanently placed in the vehicle. Another disadvantage is that an unauthorized person (a thief) could find the hidden key transponder, disconnect the immobilizer, and use the key transponder in a normal manner in the ignition cylinder to drive the vehicle.

An alternative technique includes recording the ID code of the key transponder into the memory of an aftermarket system, and placing an inductive coil of the aftermarket system near the original equipment or factory immobilizer coil. The aftermarket system may also include a memory that stores the key transponder ID, a receiver, and a microcontroller. In such a system, the receiver receives signals from the remote controller, which is typically carried by the user. When a remote start signal is transmitted from the remote controller and received at the receiver of the aftermarket system, the ID code stored in the memory is transmitted to a transceiver coupled to the immobilizer coil (which may surround or otherwise be near the ignition cylinder coil) through the dedicated inductive coil of the aftermarket system, mimicking the actual key. The passive anti-theft system recognizes the ID code as authentic and allows engine starting and operation of the vehicle.

In yet another technique, a microcontroller-based unit with a wound car coil, peak detector hardware, comparators, and firmware designed to transmit energy to a key transponder is used to read information back from the transponder by detecting the RF modulation resulting from the electrical coupling signal variances. A transponder device is used that includes a silicon memory chip (usually with on-board rectification bridge and other RF front-end devices), a wound or printed input/output coil, and (at lower frequencies) a tuning capacitor. The RF sine wave generated by the wound car coil transmits energy to the transponder and retrieves data from the transponder.

In the system, the car coil from the vehicle continuously generates an RF signal, often at 125 KHz, and continuously listens for a modulation signal to occur. Detection of the modulation of the field is indicative that a transponder has entered the RF field generated by the coil. Once the transponder has received sufficient energy to operate correctly, it divides down the RF signal to calibrate and begins clocking its data to an output transistor, which is normally connected across the coil inputs. The transponder's output transistor shunts the internal transponder coil, causing a momentary fluctuation (dampening) of the RF signal, which is seen as a slight change in amplitude of the signal. The car coil detects the peak amplitude-modulated data and processes the resulting RF data signal according to the encoding and data modulation methods used.

Recently, some vehicle manufacturers have modified passive anti-theft systems to consolidate system components within a smaller set of modules or even within a single module. This has resulted in challenges for aftermarket installer of remote start system in accessing the vehicles' passive anti-theft systems to bring an inductive coil in close enough proximity to the immobilizer coil wrapped around or otherwise near the ignition cylinder, as is needed to establish an inductive link.

A need in the art exists for convenient, effective, and efficient ways to install and setup aftermarket remote start devices and upgrades to factory security systems in vehicles with passive anti-theft immobilizer systems. A need in the art exists for apparatus and methods for retrofitting remote starting systems in vehicles with transponder-based immobilizers and/or passive anti-theft systems, without adversely affecting or unnecessarily reducing utility and/or reliability of such systems. A need in the art exists for systems that allow simple and convenient installation and configuration of the bypass systems without gaining direct access to the modules of the immobilizer systems. There is also a need in the art for aftermarket systems that bypass the verification routine of immobilizer systems or mimic the coded signal normally transmitted by the key transponder for engine starting. There is a need in the art for aftermarket remote start systems that preserve the normal operation and performance of the vehicle passive anti-theft systems.

### SUMMARY

Systems and methods described in this document are directed to meeting some of this and/or other needs. Selected embodiments use local RF transmissions at higher power than can be obtained by the inductive coupling of the passive anti-theft system and allow for communication with the passive anti-theft system at a distance from the coil. This reduces aftermarket product wiring, installation time and complexity. Selected embodiments emulate the factory anti-theft systems and allow for maintaining the security features of the factory systems.

In an embodiment, a bypass system for a vehicle equipped with an immobilizer with an immobilizer coil and operative with a passive transponder authorized to start the vehicle is provided. The bypass system includes a processor; a memory device coupled to the processor, the memory device storing a timing sequence emitted by the passive transponder; a bypass coil; and electronic circuitry coupled to the bypass coil and to the processor. The electronic circuitry is configured to drive the bypass coil under control of the processor. The processor is configured so that, in response to receipt of a vehicle start command, the processor causes the electronic circuitry to: (1) read the timing sequence from the memory device; and (2) drive the bypass coil with an emulated transponder signal on frequency of the immobilizer coil, the emulated transponder signal being encoded by the timing sequence with active reinforcement so that (i) when the timing sequence corresponds to a low level (i.e., low relative to a high level) magnetic field at the immobilizer coil, the emulated transponder signal is substantially out-of-phase with immobilizer coil signal, and (ii) when the timing sequence corresponds to the high level magnetic field at the immobilizer coil, the emulated transponder signal is substantially in-phase with the immobilizer coil signal.

In an embodiment, a method for remote start of a vehicle includes storing in a memory device of a bypass system installed in the vehicle a timing sequence emitted by a passive transponder authorized by an immobilizer installed in the vehicle to start the vehicle. The method also includes receiving a vehicle start command by the bypass system installed in the vehicle. The method further includes driving the bypass coil with an emulated transponder signal on frequency of an immobilizer coil of the immobilizer, the emulated transponder signal being encoded by the timing sequence with active reinforcement so that (1) when the timing sequence corresponds to a low level magnetic field (i.e., low level magnetic field relative to a high level magnetic field) at the immobilizer coil, the emulated transponder signal is substantially out-of-phase with immobilizer coil signal, and (2) when the timing sequence corresponds to the high level magnetic field at the immobilizer coil, the emulated transponder signal is substantially in-phase with the immobilizer coil signal, the step of driving being performed in response to receipt of a vehicle start command by the bypass system.

In an embodiment, a method for remote start of a vehicle includes storing in a memory device of a bypass system installed in the vehicle a timing sequence emitted by a passive transponder authorized by an immobilizer installed in the vehicle to start the vehicle. The method also includes receiving a vehicle start command by the bypass system installed in the vehicle. The method additionally includes step for driving the bypass coil with an emulated transponder signal on frequency of an immobilizer coil of the immobilizer, the emulated transponder signal being encoded by the timing sequence with active reinforcement. The method further includes a step for reinforcing the emulated transponder signal. The step for driving and the step for reinforcing are performed in response to receipt of a vehicle start command by the bypass system.

These and other features and aspects of the present invention will be better understood with reference to the following description, drawings, and appended claims.

### BRIEF DESCRIPTION OF THE FIGURES

FIG. 1 illustrates selected components of an immobilizer or passive anti-theft bypass system and a remote controller for the system;

FIG. 2 illustrates selected aspects of variations in the signals used for immobilizer-key transponder communications;

FIG. 3 illustrates selected aspects of FSK data modulation with NRZ encoding;

FIG. 4 illustrates selected aspects of Phase Shift Keying (PSK) data modulation;

FIG. 5 illustrates selected steps of a process for setting up of an immobilizer bypass system, such as the system of FIG. 1;

FIG. 6 illustrates selected steps of a process for operation of an immobilizer bypass system, such as the system of FIG. 1; and

FIG. 7 illustrates selected aspects of the mutual authentication and password checking routine between a vehicle immobilizer and the key transponder.

### DETAILED DESCRIPTION

In this document, the words “embodiment,” “variant,” “example,” and similar expressions refer to a particular apparatus, process, or article of manufacture, and not necessarily to the same apparatus, process, or article of manufacture. Thus, “one embodiment” (or a similar expression) used in one place or context can refer to a particular apparatus, process, or article of manufacture; the same or a similar expression in a different place can refer to a different apparatus, process, or article of manufacture. The expression “alternative embodiment” and similar expressions and phrases are used to indicate one of a number of different possible embodiments. The number of possible embodiments is not necessarily limited to two or any other quantity. Characterization of an item as “exemplary” means that the item is used as an example. Such characterization of an embodiment does not necessarily mean that the embodiment is a preferred embodiment; the embodiment may but need not be a currently preferred embodiment. The embodiments are described for illustration purposes and are not necessarily strictly limiting.

The words “couple,” “connect,” and similar expressions with their inflectional morphemes do not necessarily import an immediate or direct connection, but may include connections through mediate elements within their meaning, unless otherwise specified or inherently required.

Other and further definitions and clarifications of definitions may be found throughout this document.

Reference will now be made in detail to several embodiments and accompanying drawings. Same reference numerals are used in the drawings and the description to refer to the same apparatus elements and method steps. The drawings are in simplified form, not to scale, and omit apparatus elements and method steps that can be added to the described apparatus and methods, while including certain optional elements and steps.

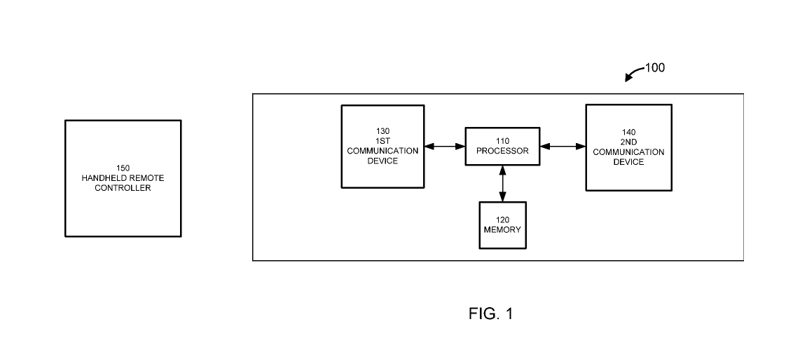

FIG. 1 illustrates selected components of (1) an immobilizer or passive anti-theft bypass system 100, and (2) a remote controller 150 for controlling some or all of the aspects of operation of the system 100 and issuing commands to the vehicle in which the system 100 is installed. The system 100 includes one or more processors 110 coupled to a memory 120. For clarity, we may refer to the processor 110 and the memory 120 in the singular, but, as those skilled in the art will readily understand after perusal of this document and the related application, multiple processors and/or multiple memory devices may be used in variants. The processor 110 may be or include, for example, a microprocessor, a microcontroller, an application specific integrated circuit (ASIC), a collection of discrete components, a field-programmable gate array, or a similar device. The memory 120 may be or include volatile memory such as dynamic random access memory (DRAM), flash memory, Read Only Memory (ROM), Electrically Programmable ROM (EPROM), Electrically Erasable Programmable ROM (EEPROM) or other forms of non-transitory storage media known in the art, whether volatile or non-volatile. The memory 120 may store the code executable by the processor 110. In variants (particularly those where the processor 110 is a microcontroller), the memory 120 may be part of the processor 110. The processor 110 may read the code and/or other data from the memory 120. The processor 110 may also write into the memory 120.

The system 100 also includes a first communication device 130 configured to communicate with the remote controller 150. The first communication device 130 may be an RF receiver or transceiver. One of its functions is to receive commands from the remote controller 150, such as remote start commands. For example, the first communication device 130 may be configured to receive an RF signal modulated according to a predetermined scheme. The signal may be encoded with a predetermined identifier, such as a predetermined binary sequence stored in the remote controller 150. The signal may also be encoded with a command to be performed by the system 100, for example, a remote start command. The first communication device 130 is configured to demodulate the RF signal according to a predetermined modulation/demodulation scheme of the communication link between the system 100 and the remote controller 150. The first communication device 130 is configured to allow the processor 110 to read the received identifier and command. The processor 110 may then compare the received identifier to one or more authorized identifiers stored in the memory 120, and, in response to a match, perform steps needed to execute the command, for example, start the engine of the vehicle in which the system 100 is installed. Additional commands may exist in variants, such as commands for opening the trunk/lift gate, opening windows, sliding a side door to open or close it, turning on/off air conditioning or heat, and still other commands.

The remote controller 150 and the first communication device 130 may be configured for medium range communication, for example, with the power up to the maximum level applicable to remote keyless entry systems by the Federal Communication Commission (FCC) regulations.

In variants, the first communication device 130 may be a receiver; in other variants, it may be a transceiver (receiver/transmitter combination), configured to transmit some data to the remote controller 150, in addition to receiving commands from the remote controller 150.

The system 100 may additionally include a second communication device 140, for communication with the induction coil of the vehicle's passive anti-theft system (the “immobilizer coil,” which may be wrapped around or otherwise placed in the immediate proximity of the ignition cylinder of the vehicle). The immobilizer coil is configured to couple (loosely) in an inductive, transformer-like manner, with the key transponder when the key transponder is near, such as when the key with the transponder is inserted into the ignition cylinder of the vehicle. The second communication device may also communicate with a key transponder, for example, in the course of setup of the system 100.

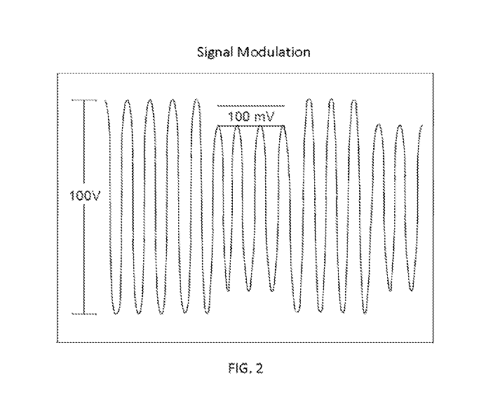

Some additional background may help in understanding the components, their configuration and interoperation, and overall functionality of selected embodiments and variants of the second communication device 140. In many immobilizer systems, data is transferred by amplitude-modulation of the signal that inductively couples the key transponder to the immobilizer coil. The link between the immobilizer coil and the key transponder behaves essentially as a loosely coupled transformer; as the secondary winding (transponder) is momentarily shunted, the primary winding (vehicle's coil) experiences a momentary voltage drop. As discussed above, the vehicle's inductive coil emits a relatively low frequency signal, e.g., a constant 125 KHz or 135 KHz. The key transponder absorbs sufficient energy to power circuits within the key transponder. When energized, the key transponder may configure a timer and then periodically shunt an internal transponder coil winding, thereby varying the power absorbed by the key transponder coil and changing the electromagnetic field. This in turn changes the impedance seeing by the circuitry that drives the immobilizer coil. By repeatedly shunting the key transponder coil circuit through a switch (e.g., a switching transistor), information is transmitted to the anti-theft system. This process is sometime referred to as absorption modulation. In variants, the vehicle's anti-theft system may detect variations in the signal at the immobilizer coil that are below the reference level by about a factor of 1000 (about 100 mV riding on a 100V sine wave). This is illustrated in FIG. 2. The information may include the identifier of the key transponder, the code for a specific command (such as remote start command), and possibly other data.

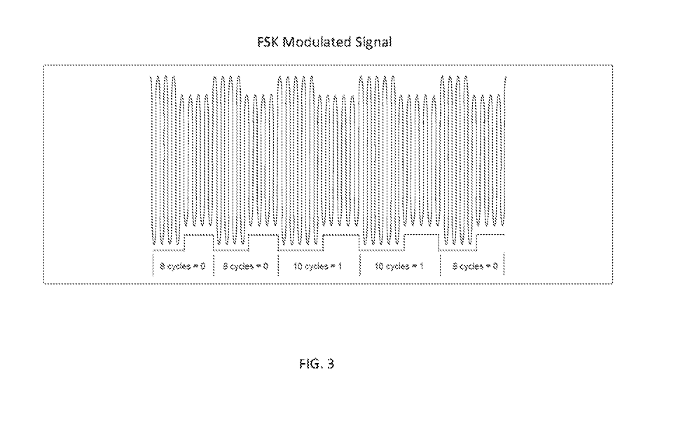

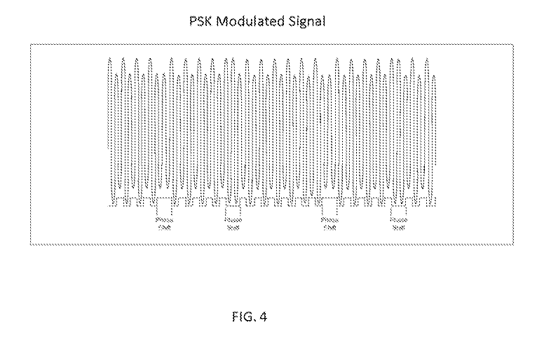

Thus, the amplitude-modulation loading of the immobilizer coil provides a communication path from the key transponder to the in-vehicle immobilizer system. The data bits can be encoded or further modulated in a number of ways. Three modulation methods are considered here, but others are contemplated. In direct modulation, a peak (relatively large) signal in the signal clock cycle period is a “1” bit, and a trough (relatively low) is a “0” bit. Direct modulation can provide a high data rate, but may also suffer from low noise immunity; this may also be referred to as Amplitude Shift Keying (ASK), a species of amplitude modulation. In Frequency Shift Keying (FSK), the form of modulation uses two different frequencies for data transfer; a common FSK mode is Fc/8/10. In other words, a “0” is transmitted as an amplitude modulated clock cycle with period corresponding to the carrier frequency divided by 8, and a “1” is transmitted as an amplitude-modulated clock cycle period corresponding to the carrier frequency divided by 10. The amplitude modulation of the carrier thus switches from Fc/8 to Fc/10, corresponding to 0's and 1's in the signal, and in-vehicle anti-theft system counts the cycles between the peak-detected clock edges to decode the data. (Of course, the 8 and 10 divisors are exemplary; in general, the two resulting frequencies are different.) While Frequency Shift Keying may allow for a simple design and may provide improved noise immunity, but it may suffer from a lower data rate than some other forms of data modulation. FIG. 3 illustrates selected aspects of FSK data modulation with Manchester encoding. FIG. 4 illustrates selected aspects of Phase Shift Keying (PSK) data modulation. This is similar to FSK, but generally uses one frequency, and the shift between 1's and 0's is accomplished by shifting the phase of the backscatter clock by 180 degrees. Two common types of PSK are change phase at any “0” bit, and change phase at any data change (“0” bit to “1” bit, or “1” bit to “0” bit). Phase Shift Keying may provide fairly good noise immunity, a moderately simple reader design, and a faster data rate than FSK.

Returning now to the description of the system 100, the second communication device 140 is such that it, under control of the processor 110, mimics the presence of a key transponder within the vehicle. In embodiments, the second communication device 140 includes a bypass coil operated (e.g., shunted and/or open-circuited and/or driven with a waveform) by circuitry controlled by the processor 110. The circuitry thus includes an interface to the processor 110, for example, a serial interface, a pair (or more lines), or other means to enable the processor 110 to configure the circuitry and obtain information from the second communication module 140. The circuitry of the second communication module 140 may further include a waveform generator and a signal driver configured to drive the bypass coil with a frequency identical or close to the frequency emitted by the immobilizer coil (e.g., 125 KHz, 13.56 MHz). This frequency may be programmable to enable the system 100 to operate in different car makes and models, and with different anti-theft systems. The circuitry also includes a signal detector coupled to the bypass coil, to enable the system 100 to read the information from key transponders, which may be performed in the same or substantially the same manner as this is done by vehicle anti-theft systems described above. For instance, the signal detector may include an analog-to-digital converter (ADC) that, when appropriately configured by the processor 110 through the interface of the second communication device 140, digitizes the level of the signal appearing across the bypass coil. The ADC may be read by the processor 110 through the interface, or it may clock its output to a memory of the second communication device 140, which is then read by the processor 110. Other configurations to implement this functionality are possible.

For the system 100 to mimic the signal resulting from presence of the key transponder in the vehicle, the second communication module 140 operates on the same frequency as the immobilizer coil. The system 100 is configured to learn the identifier of an authorized key transponder, and then emulates the presence of the key transponder in response to receiving a remote start command. The preceding is handled in two processes. The first is the setup/installation/learning process (which may also be referred to as the initial programming mode), and the second is the normal operation process.

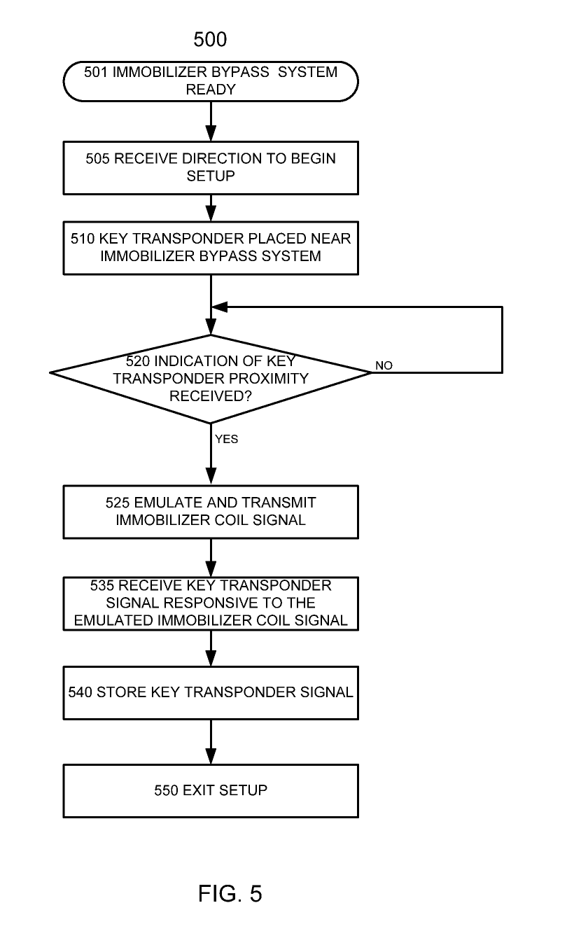

FIG. 5 illustrates selected steps of a process 500 for performing the setup of an immobilizer bypass system, such as the system 100. At flow point 501, the system 100 has been installed in the vehicle, connected to power and ground, and is ready to be set up.

In step 505, the system receives some indication that the setup process is to be performed. For example, the user may press a button or a button combination or sequence on the remote controller device 150, which sends a command to the system 100 to enter the setup mode. As another example, the user may press a button or a combination or sequence of buttons, on the system 100. As yet another example, the system 100 defaults to the setup mode. The system 100 is thus placed in, or defaults to, the initial programming mode whereby when the system 100 is located within the inductive RF emission field of the immobilizer coil and signal recognition begins. When the second communication device 140 receives the signal from the immobilizer coil, it electrically communicates it to the processor 110, which analyses the signal to determine its frequency and, if applicable, its data structuring format. The format (direct modulation, FSK, PSK, or another) may be determined by comparing the modulation variance of the received immobilizer coil signal to modulation variance of known signal patterns stored in the bypass module memory. (Note, however, that the signal emitted by the immobilizer coil may simply be a constant amplitude frequency and not carry any data.) When the received signal format matches a format in memory the matched format structure is selected for use in communicating and responding to the immobilizer coil signal transmission. The relevant information regarding the signal of the transmitted from the immobilizer coil is then stored into the memory 120.

In step 510, the vehicle's key transponder is placed near the system 100, and particularly within proximity of the second communication module 140, so that the key transponder and the second communication device 140 can establish an inductive, loose transformer-like link. This step may be performed by a person in response to an indication provided by the system 100 and/or the remote controller 150. For example, an LED may blink, possibly in a predetermined sequence.

Decision block 520 implements a loop in which the system 100 awaits receipt of an indication from the user that the key transponder has been placed in the proximity of the second communication device 140. For example, the user may press a button or a button combination or sequence on the remote controller device 150, which sends to the system 100 an indication that the key transponder has been placed near the system 100. As another example, the user may press a button or a combination or sequence of buttons, on the system 100. The process flow loops until the indication is received. In response to the receipt of the indication, the process flow proceeds to step 525.

In the step 525, the system 100 retrieves from the memory 120 the information regarding the signal transmitted from the immobilizer coil, synthesizes an emulated vehicle signal, and emits it through the bypass coil. In particular, the emulated signal may have the same frequency, modulation (if applicable), and other signal structure format as the original signal recorded in the step 505. The similarity of the emulated signal and the original signal from the immobilizer coil may be such that the key transponder behaves in the same manner it would have in response to the original signal from the immobilizer coil. In essence, the key transponder cannot distinguish between a transmission from the immobilizer coil and the transmission of the emulated immobilizer coil signal from the system 100, because of their identical or similar frequencies and signal structure formats.

As a result, the key transponder will then function in the ordinary manner to inductively absorb sufficient energy to power its circuits, and perform other functions it would perform in response the original signal from the immobilizer coil. For example, the key transponder may calibrate a timer and begin a timed shunting sequence, which may cause field modulation.

In step 535, the resulting signal from the key transponder is received by the second communication device 140 through the bypass coil.

In step 540, the processor 110 stores in the memory 120 the timing of the sequence generated by the key transponder response signal. This completes the learning routine of the setup.

In step 550, the system 100 exits from the setup process. The exit may be timed with automatic default to the operation mode after a preset period of time has elapsed. The exit may also result from some sort of an input trigger; for example, a user may press a button or a button combination or sequence on the remote controller device 150. As another example, the user may press a button or a combination or sequence of buttons, on the system 100.

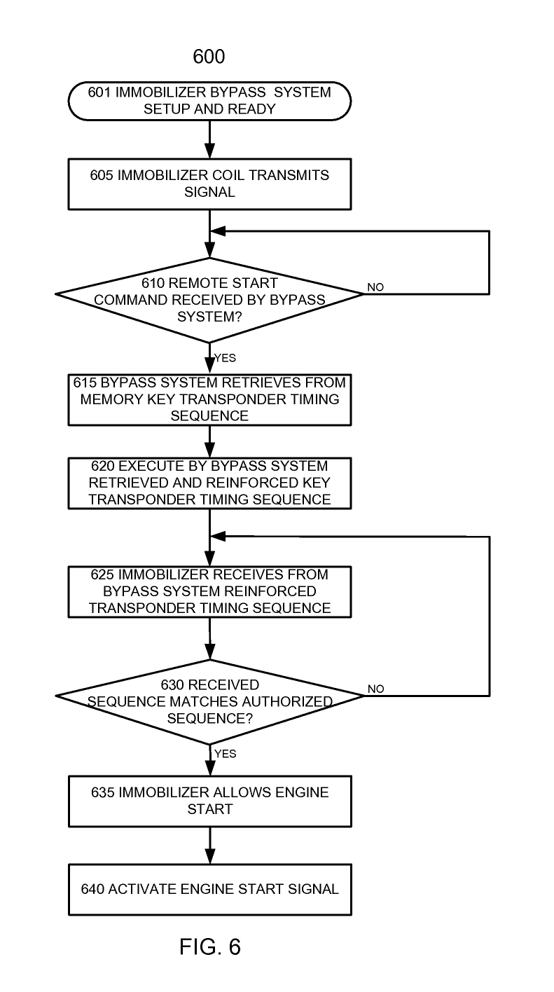

FIG. 6 illustrates selected steps of a process 600 for operation of an immobilizer bypass system, such as the system 100. At flow point 601, the system 100 has been installed in the vehicle, connected to power and ground, setup (that is, configured, for example, as has been described above in relation to FIG. 5), and is ready to function.

In step 605, the immobilizer coil transmits (generally, in a continuous manner) a signal. The frequency of the signal may be, for example, 125 KHz. Recall that the system 100 has determined the characteristics of this signal in the course of the setup process 500.

In a waiting loop formed by decision block 610, the system 100 awaits receipt of a remote start command. Until the remote start command is received, the loop returns to the input of the decision block 610. In response to the receipt of the remote start command (e.g., from the remote controller 150 through the first communication device 130), process flow advances to steps 615 and 620, to perform a transponder signal emulation, such as execution of the timing sequence previously stored in the memory 120.

In the step 615, the system 100 retrieves from the memory 120 the key transponder timing sequence that was previously recorded into the memory 120 during the process 500. As discussed above in relation to the setup process 500, the key transponder circuitry periodically shunts the internal coil of the key transponder, resulting in a modulated voltage of the induction signal detected by the vehicle's immobilizer system through the immobilizer coil. When shunted, the induction within the transponder coil is interrupted, causing slight voltage modulation. The timing of the shunting sequence provides a data coding means that represents a unique identification or authorizations to the individual transponder.

In the step 620, the processor 110 configures the second communication device 140 and causes it to execute the retrieved timing sequence. In variants, the same timing sequence that was stored in the setup process 500 is executed here. In variants, however, the timing sequence is “reinforced,” as follows. The shunt timing sequence is converted to an amplitude modulation sequence whereby the second communication device 140 of the system 100 emits an amplitude modulated RF signal on the same frequency as the immobilizer coil emission. The modulated signal transmitted from the second communication device 140 system 100 is either substantially in-phase or substantially out of phase with the RF signal transmitted from the immobilizer coil, in a manner corresponding to the shunt timing of the key transponder.

In embodiments, the phase of the signal emitted by the second communication device is within 1 degree of the phase of the signal emitted by the immobilizer coil when the two signals are in-phase; and the phase of the signal emitted by the second communication device is between 179 degrees and 181 degrees of the phase of the signal emitted by the immobilizer coil when the two signals are out-of-phase. In more specific embodiments, the phase of the signal emitted by the second communication device is within 10 degrees of the phase of the signal emitted by the immobilizer coil when the two signals are in-phase; and the phase of the signal emitted by the second communication device is between 170 degrees and 190 degrees of the phase of the signal emitted by the immobilizer coil when the two signals are out-of-phase. In still more specific embodiments, the phase of the signal emitted by the second communication device is within 20 degrees of the phase of the signal emitted by the immobilizer coil when the two signals are in-phase; and the phase of the signal emitted by the second communication device is between 160 degrees and 200 degrees of the phase of the signal emitted by the immobilizer coil when the two signals are out-of-phase. In still more specific embodiments, the phase of the signal emitted by the second communication device is within 30 degrees of the phase of the signal emitted by the immobilizer coil when the two signals are in-phase; and the phase of the signal emitted by the second communication device is between 150 degrees and 210 degrees of the phase of the signal emitted by the immobilizer coil when the two signals are out-of-phase.

Thus, the bypass coil of the second communication device 140 transmits a signal at the same frequency as the immobilizer coil signal and in-phase or out-of-phase, to reinforce the “1” and “0” bits as compared to the case where the bypass coil (or the key transponder coil) where passively shunted with the timing signal. When the two signals (one from the immobilizer coil, the other from the bypass coil) are in-phase, the electromagnetic fields combine constructively at the immobilizer coil; when the two signals are out-of-phase, the two fields combine destructively at the immobilizer coil. Thus, active reinforcement occurs so that the highs are higher and the lows lower than they would have been with passive shunting, allowing the bypass coil to be placed farther from the immobilizer coil and still emulate the presence of the key transponder nearby.

In step 625, the immobilizer of the vehicle receives, through the immobilizer coil, the timing sequence emitted by the system 100. In decision block 630, the immobilizer compares the received (sensed) timing sequence to the signatures (IDs) of one or more authorized key transponders. Because the received (sensed) timing sequence appears to the immobilizer as if it came from the key transponder used in the setup process, the immobilizer allows the vehicle to start, in step 635.

In step 640, the system 100 activates a signal to start the engine of the vehicle.

In embodiments, the degree of reinforcement is adjustable, for example, during the setup process. The adjustment can be effected by changing the driving current that the system 100 applies to the bypass coil. The degree of adjustment may be determined manually, during the installation process. The degree of reinforcement may be determined separately for in-phase and out-of-phase emissions of the bypass coil. For example, a number of settings for in-phase and a number of settings for out-of-phase, reinforcement may be provided in the system 100. The particular settings may be set/changed by programming, by rotating adjustable components (e.g., variable resistor(s)), and/or otherwise. After the setup process 500 has been performed, the operation of the system may be tested to see if remote start occurs in response to a remote start command issued from the remote controller 150. The specific setting(s) may be selected from the one or more settings the remote start function operates properly.

In embodiments, the system 100 may analyze the shunt timing and generate a corresponding wave form. The signal shunt timing sequence as discussed above is extracted from transponder transmission signal and converted to a waveform transmission sequence corresponding to the transponder signal. The waveform is then stored in the memory 120. When the remote start command is received from the remote controller 150, the corresponding transmission waveform signal is retrieved and transmitted to the immobilizer coil.

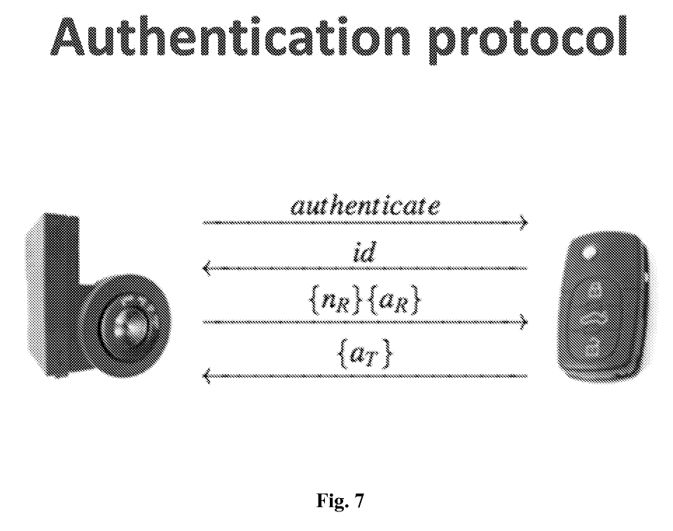

Tables 1-6 below and FIG. 7 explain, for selected embodiments, the mutual authentication and password checking routine between a vehicle immobilizer and the key transponder.

TABLE 1
(PREAMBLE)

Electronic vehicle immobilizer - anti-theft device.
Prevents the engine of the vehicle from starting unless
the corresponding transponder is present.
Passive RFID tag embedded in the car key
Hitag2
Proprietary stream cipher
48-bit keys for authentication and confidentiality.

TABLE 2
(SELECTED FUNCTIONALITY)

Public mode - contents of the user data pages are simply broadcast
by the transponder
Password mode - reader and transponder password authentication.
Replay attack possible.
Crypto mode - mutual authenticationof reader and transponder by
means of a 48-bit shared key encrypted using a proprietary stream
cipher.

TABLE 3
(ASPECTS OF MEMORY)
MEMORY
256 bits of non-volatile memory (EEPROM)
Organized in 8 blocks of 4 bytes each.
In crypto mode -

| Block | Contents |
|---|---|
| 0 | transponder identifier id |
| 1 | secret key low k₀ . . . k₃₁ |
| 2 | secret key high k₃₂ . . . k₄₇ - reserved |
| 3 | configuration - password |
| 4-7 | user defined memory |

TABLE 4
(SELECTED ASPECTS OF COMMUNICATION)
Communication

Master-slave principle
Reader sends a command to the transponder
Transponder responds after a predefined period of time
There are five different commands:
authenticate, read, read, write, halt.

TABLE 5
(SELECTED ASPECTS OF COMMUNICATION CONT'D)

| Command | Bits | State |
|---|---|---|
| authenticate | 11000 | halted |
| read | 11n₀n₁n₂00 n̅₀̅n̅₁̅n̅₂̅ . . . | active |
| r̅e̅a̅d̅ | 01n₀n₁n₂10 n̅₀̅n̅₁̅n̅₂̅ . . . | active |
| write | 10n₀n₁n₂01 n̅₀̅n̅₁̅n̅₂̅ . . . | active |
| halt | 00n₀n₁n₂11 n̅₀̅n̅₁̅n̅₂̅ . . . | active |

TABLE 6
(SELECTED ASPECTS OF CIPHER)
Cipher

48-bit linear feedback shift register (LFSR)
Non-linear filter function f.
Twenty bits of the LFSR generate one bit of keystream.
LFSR shifts one bit to the left
Uses the generating polynomial to generate a new bit on the right.

It should be noted that a plurality of authorized transponder keys can be programmed into the bypass module memory. This allows multiple authorized vehicle users to issue commands, such as engine start, remotely. When multiple key transponders are programmed, a master slave arrangement may be implemented to limit authorization of certain key transponders to perform only selected remote operations or programming features. For example, certain keys may be allowed to transmit a start command only at specified times of the day or on specified day. In this way, fleets of vehicles can be managed.

The system and process features described throughout this document may be present individually, or in any combination or permutation, except where presence or absence of specific feature(s)/element(s)/limitation(s) is inherently required, explicitly indicated, or otherwise made clear from the context.

Although the process steps and decisions (if decision blocks are present) may be described serially in this document, certain steps and/or decisions may be performed by separate elements in conjunction or in parallel, asynchronously or synchronously, in a pipelined manner, or otherwise. There is no particular requirement that the steps and decisions be performed in the same order in which this description lists them or the Figures show them, except where a specific order is inherently required, explicitly indicated, or is otherwise made clear from the context. Furthermore, not every illustrated step and decision block may be required in every embodiment in accordance with the concepts described in this document, while some steps and decision blocks that have not been specifically illustrated may be desirable or necessary in some embodiments in accordance with the concepts. It should be noted, however, that specific embodiments/variants/examples use the particular order(s) in which the steps and decisions (if applicable) are shown and/or described.

This document describes in detail the inventive immobilizer bypass systems and methods for their setup and operation. This was done for illustration purposes. Neither the specific embodiments of the invention(s) as a whole, nor those of its features necessarily limit the general principles underlying the invention(s). The specific features described herein may be used in some embodiments, but not in others, without departure from the spirit and scope of the invention as set forth herein. Various physical arrangements of components and various step sequences also fall within the intended scope of the invention. Many additional modifications are intended in the foregoing disclosure, and it will be appreciated by those of ordinary skill in the art that in some instances some features of the invention will be employed in the absence of a corresponding use of other features. The illustrative examples therefore do not necessarily define the metes and bounds of the invention(s) and the legal protection afforded the invention(s). For a better understanding, those skilled in the art should consider the claims and their equivalents.

We claim:

1. A bypass system for a vehicle equipped with an immobilizer comprising an immobilizer coil and operative with a passive transponder authorized to start the vehicle, the bypass system comprising:
a processor;
a memory device coupled to the processor, the memory device storing a timing sequence emitted by the passive transponder;
a bypass coil;
electronic circuitry coupled to the bypass coil and to the processor, the electronic circuitry being configured to drive the bypass coil under control of the processor;
wherein the processor is configured so that, in response to receipt of a vehicle start command, the processor causes the electronic circuitry to:
read the timing sequence from the memory device; and
drive the bypass coil with an emulated transponder signal on frequency of the immobilizer coil, the emulated transponder signal being encoded by the timing sequence with active reinforcement so that (1) when the timing sequence corresponds to a low level magnetic field at the immobilizer coil, the emulated transponder signal is substantially out-of-phase with immobilizer coil signal, and (2) when the timing sequence corresponds to a high level magnetic field at the immobilizer coil, the emulated transponder signal is substantially in-phase with the immobilizer coil signal.

2. A bypass system as in claim 1, wherein when the timing sequence corresponds to the low level magnetic field, the emulated transponder signal is within one degree of being out-of-phase with the immobilizer coil signal, and (2) when the timing sequence corresponds to the high level magnetic field, the emulated transponder signal is within one degree of being in-phase with immobilizer coil signal.

3. A bypass system as in claim 1, wherein when the timing sequence corresponds to the low level magnetic field, the emulated transponder signal is within ten degrees of being out-of-phase with the immobilizer coil signal, and (2) when the timing sequence corresponds to the high level magnetic field, the emulated transponder signal is within ten degrees of being in-phase with immobilizer coil signal.

4. A bypass system as in claim 1, wherein when the timing sequence corresponds to the low level magnetic field, the emulated transponder signal is within twenty degrees of being out-of-phase with the immobilizer coil signal, and (2) when the timing sequence corresponds to the high level field, the emulated transponder signal is within twenty degrees of being in-phase with immobilizer coil signal.

5. A bypass system as in claim 1, wherein the processor is configured to obtain through the bypass coil and the electronic circuitry the timing sequence from the passive transponder and store the timing sequence in the memory device.

6. A bypass system as in claim 1, wherein the processor is further configured so that, in response to receipt of the vehicle start command, the processor activates an engine start signal of the vehicle to cause an engine of the vehicle to start.

7. A bypass system as in claim 1, further comprising a medium range radio frequency (RF) communication device coupled to the processor to allow the processor to receive the vehicle start command from a remote controller.

8. A bypass system as in claim 1, further comprising:
a remote controller; and
a radio frequency (RF) communication device coupled to the processor to allow the processor to receive the vehicle start command from the remote controller through the radio frequency communication device.

9. A bypass system as in claim 1, wherein the frequency of the immobilizer coil is about 125 KHz or about 135 kHz.

10. A bypass system as in claim 1, wherein the frequency of the immobilizer coil is about 13.56 MHz.

11. A method for remote start of a vehicle, the method comprising steps of:
storing in a memory device of a bypass system installed in the vehicle a timing sequence emitted by a passive transponder authorized by an immobilizer installed in the vehicle to start the vehicle;
receiving a vehicle start command by the bypass system installed in the vehicle;
driving the bypass coil with an emulated transponder signal on frequency of an immobilizer coil of the immobilizer, the emulated transponder signal being encoded by the timing sequence with active reinforcement so that (1) when the timing sequence corresponds to a low level magnetic field at the immobilizer coil, the emulated transponder signal is substantially out-of-phase with immobilizer coil signal, and (2) when the timing sequence corresponds to a high level magnetic field at the immobilizer coil, the emulated transponder signal is substantially in-phase with the immobilizer coil signal, the step of driving being performed in response to receipt of a vehicle start command by the bypass system.

12. A method as in claim 11, wherein when the timing sequence corresponds to the low level magnetic field at the immobilizer coil, the emulated transponder signal is within one degree of being out-of-phase with the immobilizer coil signal, and (2) when the timing sequence corresponds to the high level magnetic field at the immobilizer coil, the emulated transponder signal is within one degree of being in-phase with immobilizer coil signal.

13. A method as in claim 11, wherein when the timing sequence corresponds to the low level field at the immobilizer coil, the emulated transponder signal is within ten degrees of being out-of-phase with the immobilizer coil signal, and (2) when the timing sequence corresponds to the high level field at the immobilizer coil, the emulated transponder signal is within ten degrees of being in-phase with immobilizer coil signal.

14. A method as in claim 11, wherein when the timing sequence corresponds to the low level field at the immobilizer coil, the emulated transponder signal is within twenty degrees of being out-of-phase with the immobilizer coil signal, and (2) when the timing sequence corresponds to the high level field at the immobilizer coil, the emulated transponder signal is within twenty degrees of being in-phase with immobilizer coil signal.

15. A method as in claim 11, further comprising:
obtaining through the bypass coil the timing sequence emitted by the passive transponder; and
storing the timing sequence in the memory device.

16. A method as in claim 11, further comprising activating by the bypass system an engine start signal of the vehicle to cause an engine of the vehicle to start, the step of activating being performed in response to receipt by the bypass system of the vehicle start command.

17. A method as in claim 11, wherein the step of receiving of the vehicle start command by the bypass system comprises receiving the vehicle start command from a remote controller through a medium range radio frequency (RF) communication device of the bypass system.

18. A method as in claim 11, wherein the step of receiving of the vehicle start command by the bypass system comprises receiving the vehicle start command from a remote controller through a medium range radio frequency (RF) communication device of the bypass system, the method further comprising:
sending the vehicle start command from the remote controller in response to an input provided by a user.

19. A method as in claim 11, wherein the frequency of the immobilizer coil is about 125 KHz.

20. A method as in claim 11, wherein the frequency of the immobilizer coil is about 13.56 MHz.

21. A method for remote start of a vehicle, the method comprising steps of:
storing in a memory device of a bypass system installed in the vehicle a timing sequence emitted by a passive transponder authorized by an immobilizer installed in the vehicle to start the vehicle;
receiving a vehicle start command by the bypass system installed in the vehicle;
step for driving the bypass coil with an emulated transponder signal on frequency of an immobilizer coil of the immobilizer, the emulated transponder signal being encoded by the timing sequence with active reinforcement; and
step for reinforcing the emulated transponder signal;
wherein the step for driving and the step for reinforcing are performed in response to receipt of a vehicle start command by the bypass system.
